(19) United States
(12) Patent Application Publication
(10) Pub. No.: US 2021/0114045 A1
(43) Pub. Date: Apr. 22, 2021

(54) Pressure Washing Assembly

(71) Applicant: Jarrod Bell, Yakima, WA (US)

(72) Inventor: Jarrod Bell, Yakima, WA (US)

(21) Appl. No.: 16/660,322

(22) Filed: Oct. 22, 2019

(51) Int. Cl. B05B 1/16; B08B 3/02

(52) U.S. Cl. CPC B05B 1/1672; B08B 3/026

(57) ABSTRACT

A pressure washing assembly includes a fluid fitting that is fluidly coupled to a fluid source. A spraying tube is removably coupled to the fitting to receive a fluid from the fluid source. The spraying tube sprays the fluid for cleaning an object. A handle is coupled to and extends laterally away from the spraying tube for gripping to enhance manipulating the spraying tube. An elbow fitting is removably attachable to the fluid fitting to receive the fluid from the fluid source. A fluid hose that a similar size with respect to the spraying hose can be attached to the elbow fitting to deliver the fluid to the fluid hose.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pressure washing device and more particularly pertains to a new pressure washing device for producing a high pressure jet of water without a pressure washer.

### (2) Description of Related Art Including Information Disclosed Under 37 CFR 1.97 and 1.98

The prior art relates to pressure washing device.

### BRIEF SUMMARY OF THE INVENTION

An embodiment of the disclosure meets the needs presented above by generally comprising a fluid fitting that is fluidly coupled to a fluid source. A spraying tube is removably coupled to the fitting to receive a fluid from the fluid source. The spraying tube sprays the fluid for cleaning an object. A handle is coupled to and extends laterally away from the spraying tube for gripping to enhance manipulating the spraying tube. An elbow fitting is removably attachable to the fluid fitting to receive the fluid from the fluid source. A fluid hose that a similar size with respect to the spraying hose can be attached to the elbow fitting to deliver the fluid to the fluid hose.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a pressure washing assembly according to an embodiment of the disclosure.

FIG. 2 is a front view of an embodiment of the disclosure.

FIG. 3 is a bottom view of a spraying tube of an embodiment of the disclosure.

FIG. 4 is an exploded perspective view of a fluid fitting and an elbow fitting of an embodiment of the disclosure.

### DETAILED DESCRIPTION OF THE INVENTION

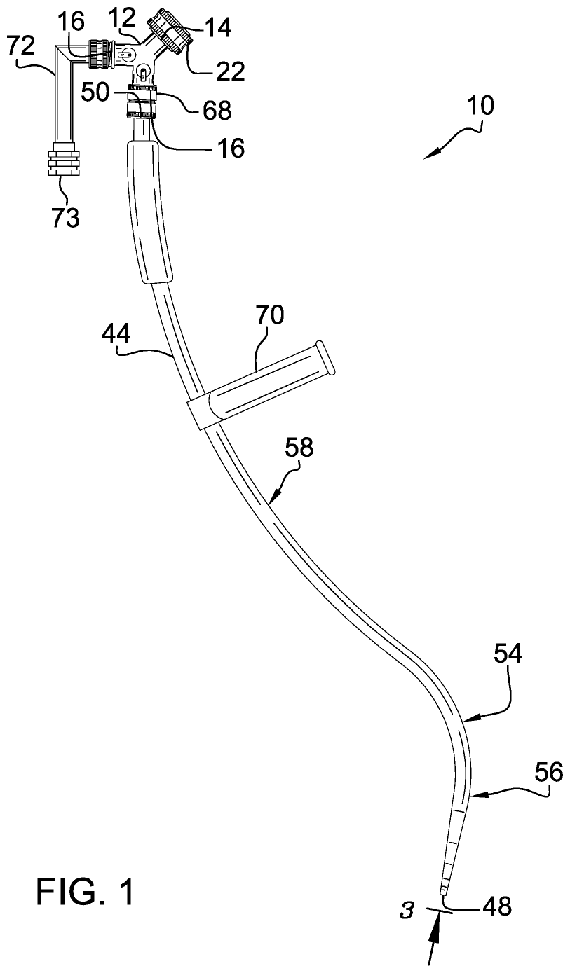

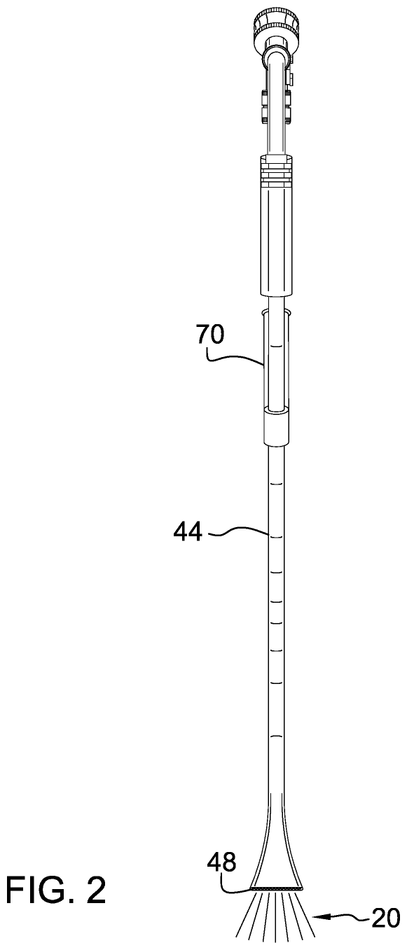

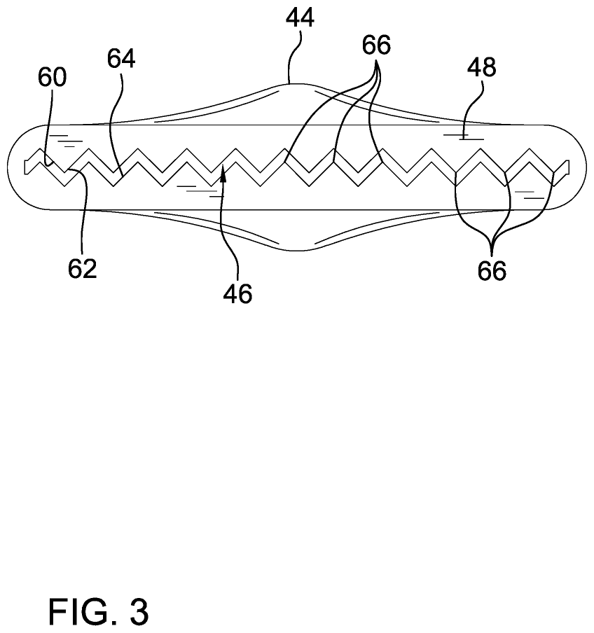

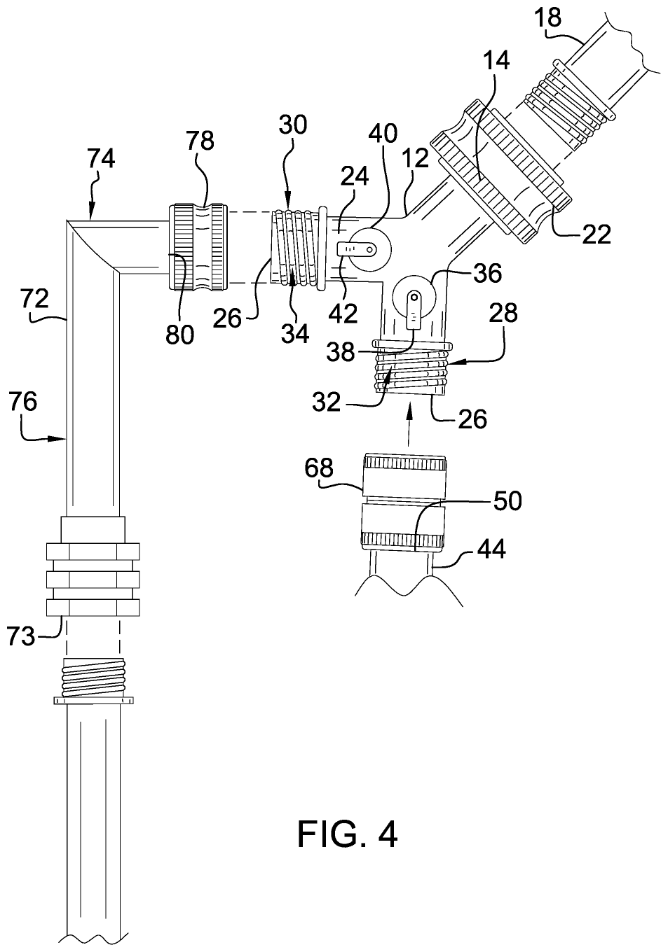

With reference now to the drawings, and in particular to FIGS. 1 through 4 thereof, a new pressure washing device embodying the principles and concepts of an embodiment of the disclosure and generally designated by the reference numeral 10 will be described.

As best illustrated in FIGS. 1 through 4, the pressure washing assembly 10 generally comprises a fluid fitting 12 that has an input 14 and a pair of outputs 16. The input 14 is fluidly coupled to a fluid source 18 thereby facilitating the fluid fitting 12 to receive a fluid 20 from the fluid source 18. The fluid source 18 may be a hose bib or other similar source of municipal water and the fluid 20 may be water. The input 14 includes a female hose coupler 22 for threadably engaging a male end of a hose thereby facilitating the input 14 to receive fluid from the hose. The hose may be a garden hose that is attached to the hose bib.

Each of the outputs 16 is in fluid communication with the input 14, each of the outputs 16 has an outer wall 24 and each of the outputs 16 has a distal end 26 with respect to the input 14. The pair of outputs 16 includes a first output 28 and a second output 30. The outer wall 24 has a first threaded portion 32 that is positioned adjacent to the distal end 26 of the first output 28. The outer wall 24 has a second threaded portion 34 that is positioned adjacent to the distal end 26 of the second output 30. Additionally, the first output 28 extends along a longitudinal axis that is oriented perpendicular to a longitudinal axis of the second output 30 such that the fluid fitting 12 has a Y shape.

A first valve 36 is movably coupled to the fluid fitting 12 and the first valve 36 is aligned with the first output 28. The first valve 36 is positionable in an open condition thereby facilitating fluid 20 to flow from the input 14 to the first output 28. The first valve 36 is positionable in a closed condition thereby inhibiting the fluid 20 from flowing from the input 14 to the first output 28. The first valve 36 may comprise a mechanical fluid valve or the like. A first lever 38 is rotatably coupled to the outer wall 24 of the fitting. The first lever 38 engages the first valve 36 for manipulating the first valve 36 between the open condition and the closed condition.

A second valve 40 is movably coupled to the fluid fitting 12 and the second valve 40 is aligned with the second output 30. The second valve 40 is positionable in an open condition thereby facilitating fluid 20 to flow from the input 14 to the second output 30. The second valve 40 is positionable in a closed condition thereby inhibiting the fluid 20 from flowing from the input 14 to the second output 30. The second valve 40 may comprise a mechanical fluid valve or the like. A second lever 42 is rotatably coupled to the outer wall 24 of the fitting and the second lever 42 engages the second valve 40 for manipulating the second valve 40 between the open condition and the closed condition.

A spraying tube 44 is removably coupled to a respective one of the outputs 16 on the fitting to receive the fluid from the fluid source 18. The spraying tube 44 has a spray aperture 46 therein. The spray aperture 46 has dimensions that are less than dimensions of an interior of the spraying tube 44 thereby increasing pressure of the fluid 20 passing through the spray aperture 46. In this way the spray aperture 46 facilitates the fluid 20 to be sprayed for cleaning an object.

The spraying tube 44 has a first end 48, a second end 50 and an outer wall 52 extending therebetween. The outer wall 52 of the spraying tube 44 has a bend 54 thereon defining a first portion 56 of the spraying tube 44 that is oriented at an angle with respect to a second portion 58 of the spraying tube 44. The bend 54 is positioned closer to the first end 48 than the second end 50. The first portion 56 extends between the first end 48 and the bend 54. The second portion 58 extends between the second end 50 and the bend 54. Moreover, the second portion 58 is curved between the bend 54 and the second end 50.

The outer wall 24 is flattened adjacent to the first end 48. Additionally, the outer wall 24 flares outwardly adjacent to the first end 48 such that the first end 48 is laterally elongated with respect to an axis extending through the first end 48 and the second end 50 of the spraying tube 44. The spray aperture 46 extends through the first end 48 and the spray aperture 46 has a bounding edge 60. The bounding edge 60 has a top side 62 and a bottom side 64. Each of the top side 62 and the bottom side 64 has a plurality of peaks 66 that are staggered along an entire length of the spray aperture 46 such that the spray aperture 46 has a zig zag shape.

A spray coupler 68 is rotatably coupled to the second end 50 of the spraying tube 44. The spray coupler 68 threadably engages the first threaded portion 32 on the outer wall 24 of the fluid fitting 12 for fluidly coupling the spraying hose to the first output 28 of the fluid fitting 12. The spray coupler 68 may be a male hose coupler or the like. A handle 70 is coupled to and extends laterally away from the spraying tube 44 for gripping to enhance manipulating the spraying tube 44. The handle 70 engages the outer wall 24 of the spraying tube 44 and the handle 70 is positioned on the second portion 58 of the spraying tube 44.

An elbow fitting 72 is removably attachable to a respective one of the outputs 16 on the fluid fitting 12 to receive the fluid 20 from the fluid source 18. The elbow has a distal end 73 with respect to the respective output 16. The distal end 26 is attachable to a fluid hose that has a similar size with respect to the spraying tube 44 to deliver the fluid to the fluid hose. The fluid hose may be a garden hose or any other type of water hose. The elbow fitting 72 has a primary portion 74 forming an angle with a secondary portion 76. Additionally, the distal end 26 of the elbow fitting 72 is associated with the secondary portion 76.

A fluid coupler 78 is rotatably coupled to an end 80 of the primary portion 74 of the elbow fitting 72. The fluid coupler 78 threadably engages the second threaded portion 34 of the outer wall 24 of the fluid fitting 12 for fluidly coupling the elbow fitting 72 to the second output 30 of the fluid fitting 12. Additionally, the secondary portion 76 of the elbow fitting 72 is oriented to extend along a line that is collinear with the spraying tube 44.

In use, the input 14 of the fluid fitting 12 is coupled to the fluid source 18 and the spraying tube 44 is coupled to the first output 28 of the fluid fitting 12. The spray aperture 46 in the spraying tube 44 increases the pressure of the fluid 20 being delivered to the spraying tube 44. In this way the spraying tube 44 produces a jet of fluid similar to that of a pressure washer. Thus, the spraying tube 44 can be employed for washing a surface with a high pressure jet of fluid without the use of a pressure washer. Additionally, the elbow fitting 72 can be coupled to the second output 30 of the fluid fitting 12 thereby facilitating a garden hose to be employed at the same time that the spraying tube 44 is being employed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pressure washing assembly being configured to be fluidly coupled to a garden hose for releasing a high pressure jet of water for spraying, said assembly comprising:
a fluid fitting having an input and a pair of outputs, said input being fluidly coupled to a fluid source wherein said fluid fitting is configured to receive a fluid from the fluid source, said input including a female hose coupler for threadably engaging a male end of a hose thereby facilitating said input to receive fluid from the hose, each of said outputs being in fluid communication with said input;
a spraying tube being removably coupled to a respective one of said outputs on said fitting wherein said spraying tube is configured to receive the fluid from the fluid source, said spraying tube having a spray aperture therein, said spray aperture having a dimensions being less than dimensions of an interior of said spraying tube thereby increasing pressure of the fluid passing through said spray aperture wherein said spray aperture is configured to facilitate the fluid to be sprayed for cleaning an object;
a handle being coupled to and extending laterally away from said spraying tube for gripping to enhance manipulating said spraying tube; and
an elbow fitting being removably attachable to a respective one of said outputs on said fluid fitting wherein said elbow fitting is configured to receive the fluid from the fluid source, said elbow having a distal end with respect to said respective output, said distal end being attachable to a fluid hose having a similar size with respect to said spraying hose wherein said elbow fitting is configured to deliver the fluid to the fluid hose.

2. The assembly according to claim 1, wherein:
each of said outputs has an outer wall, each of said outputs having a distal end with respect to said input, said pair of outputs including a first output and a second output;
said outer wall has a first threaded portion being positioned adjacent to said distal end of said first output;
said outer wall has a second threaded portion being positioned adjacent to said distal end of said second output; and
said first output extends along a longitudinal axis being oriented perpendicular to a longitudinal axis of said second output such that said fluid fitting has a Y shape.

3. The assembly according to claim 2, further comprising a first valve being movably coupled to said fluid fitting, said first valve being aligned with said first output, said first valve being positionable in an open condition thereby facilitating fluid to flow from said input to said first output, said first valve being positionable in a closed condition thereby inhibiting the fluid from flowing from said input to said first output.

4. The assembly according to claim 3, further comprising a first lever being rotatably coupled to said outer wall of said fitting, said first lever engaging said first valve for manipulating said first valve between said open condition and said closed condition.

5. The assembly according to claim 4, further comprising a second valve being movably coupled to said fluid fitting, said second valve being aligned with said second output, said second valve being positionable in an open condition thereby facilitating fluid to flow from said input to said second output, said second valve being positionable in a closed condition thereby inhibiting the fluid from flowing from said input to said second output.

6. The assembly according to claim 5, further comprising a second lever being rotatably coupled to said outer wall of said fitting, said second lever engaging said second valve for manipulating said second valve between said open condition and said closed condition.

7. The assembly according to claim 2, wherein said spraying tube has a first end, a second end and an outer wall extending therebetween, said outer wall having a bend therein defining a first portion of said spraying tube being oriented at an angle with respect to a second portion of said spraying tube, said bend being positioned closer to said first end than said second end, first portion extending between said first end and said bend, said second portion extending between said second end and said bend.

8. The assembly according to claim 7, wherein said second portion is curved between said bend and said second end.

9. The assembly according to claim 8, wherein said outer wall is flattened adjacent to said first end, said outer wall flaring outwardly adjacent to said first end such that said first end is laterally elongated with respect to an axis extending through said first end and said second end of said spraying tube, said spray aperture extending through said first end.

10. The assembly according to claim 9, wherein said spray aperture has a bounding edge, said bounding edge having a top side and a bottom side, each of said top side and said bottom side having a plurality of peaks being staggered along an entire length of said spray aperture such that said spray aperture has a zig zag shape.

11. The assembly according to claim 10, further comprising a spray coupler being rotatably coupled to said second end of said spraying tube, said spray coupler threadably engaging said first threaded portion on said outer wall of said fluid fitting for fluidly coupling said spraying hose to said first output of said fluid fitting.

12. The assembly according to claim 2, wherein said elbow fitting has a primary portion forming an angle with a secondary portion, said distal end of said elbow being associated with said secondary portion.

13. The assembly according to claim 12, further comprising a fluid coupler being rotatably coupled to an end of said primary portion of said elbow fitting, said fluid coupler threadably engaging said second threaded portion of said outer wall of said fluid fitting for fluidly coupling said elbow fitting to said second output of said fluid fitting, said secondary portion of said elbow being oriented to extend along a line being collinear with said spraying hose.

14. A pressure washing assembly being configured to be fluidly coupled to a garden hose for releasing a high pressure jet of water for spraying, said assembly comprising:
a fluid fitting having an input and a pair of outputs, said input being fluidly coupled to a fluid source wherein said fluid fitting is configured to receive a fluid from the fluid source, said input including a female hose coupler for threadably engaging a male end of a hose thereby facilitating said input to receive fluid from the hose, each of said outputs being in fluid communication with said input, each of said outputs having an outer wall, each of said outputs having a distal end with respect to said input, said pair of outputs including a first output and a second output, said outer wall having a first threaded portion being positioned adjacent to said distal end of said first output, said outer wall having a second threaded portion being positioned adjacent to said distal end of said second output, said first output extending along a longitudinal axis being oriented perpendicular to a longitudinal axis of said second output such that said fluid fitting has a Y shape;
a first valve being movably coupled to said fluid fitting, said first valve being aligned with said first output, said first valve being positionable in an open condition thereby facilitating fluid to flow from said input to said first output, said first valve being positionable in a closed condition thereby inhibiting the fluid from flowing from said input to said first output;
a first lever being rotatably coupled to said outer wall of said fitting, said first lever engaging said first valve for manipulating said first valve between said open condition and said closed condition;
a second valve being movably coupled to said fluid fitting, said second valve being aligned with said second output, said second valve being positionable in an open condition thereby facilitating fluid to flow from said input to said second output, said second valve being positionable in a closed condition thereby inhibiting the fluid from flowing from said input to said second output;
a second lever being rotatably coupled to said outer wall of said fitting, said second lever engaging said second valve for manipulating said second valve between said open condition and said closed condition;
a spraying tube being removably coupled to a respective one of said outputs on said fitting wherein said spraying tube is configured to receive the fluid from the fluid source, said spraying tube having a spray aperture therein, said spray aperture having a dimensions being less than dimensions of an interior of said spraying tube thereby increasing pressure of the fluid passing through said spray aperture wherein said spray aperture is configured to facilitate the fluid to be sprayed for cleaning an object, said spraying tube having a first end, a second end and an outer wall extending therebetween, said outer wall having a bend therein defining a first portion of said spraying tube being oriented at an angle with respect to a second portion of said spraying tube, said bend being positioned closer to said first end than said second end, first portion extending between said first end and said bend, said second portion extending between said second end and said bend, said second portion being curved between said bend and said second end, said outer wall being flattened adjacent to said first end, said outer wall flaring outwardly adjacent to said first end such that said first end is laterally elongated with respect to an axis extending through said first end and said second end of said spraying tube, said spray aperture extending through said first end, said spray aperture having a bounding edge, said bounding edge having a top side and a bottom side, each of said top side and said bottom side having a plurality of peaks being staggered along an entire length of said spray aperture such that said spray aperture has a zig zag shape;
a spray coupler being rotatably coupled to said second end of said spraying tube, said spray coupler threadably engaging said first threaded portion on said outer wall of said fluid fitting for fluidly coupling said spraying hose to said first output of said fluid fitting;
a handle being coupled to and extending laterally away from said spraying tube for gripping to enhance manipulating said spraying tube, said handle engaging said outer wall of said spraying tube, said handle being positioned on said second portion of said spraying tube;
an elbow fitting being removably attachable to a respective one of said outputs on said fluid fitting wherein said elbow fitting is configured to receive the fluid from the fluid source, said elbow having a distal end with respect to said respective output, said distal end being attachable to a fluid hose having a similar size with respect to said spraying hose wherein said elbow fitting is configured to deliver the fluid to the fluid hose, said elbow fitting having a primary portion forming an angle with a secondary portion, said distal end of said elbow being associated with said secondary portion; and
a fluid coupler being rotatably coupled to an end of said primary portion of said elbow fitting, said fluid coupler threadably engaging said second threaded portion of said outer wall of said fluid fitting for fluidly coupling said elbow fitting to said second output of said fluid fitting, said secondary portion of said elbow being oriented to extend along a line being collinear with said spraying hose.
